(19) United States
(12) Patent Application Publication
(10) Pub. No.: US 2005/0164043 A1
(43) Pub. Date: Jul. 28, 2005

(54) High-pressure sensor element with an anti-rotation protection

(76) Inventors: Klaus Skrobanek, Budapest (HU); Kurt Weiblen, Metzingen (DE); Ralf Henn, Stuttgart (DE); Volker Wingsch, Reutlingen (DE)

Correspondence Address: KENYON & KENYON, ONE BROADWAY, NEW YORK, NY, 10004, US

(21) Appl. No.: 11/040,075

(22) Filed: Jan. 21, 2005

(30) Foreign Application Priority Data
Jan. 23, 2004 (DE) 102004003414.1

(51) Int. Cl. B32B 3/00

(52) U.S. Cl. 428/698; 428/209; 428/195.1

(57) ABSTRACT

A substrate having a collar, which features a marking. The substrate, in particular a thin-layer substrate, may be processed in a process having at least one micromechanical process step. In this context, given at least one micromechanical process step the successful performance of the process step is a function of the fixation of the substrate in a first position. This first position is understood as a relative position of the substrate in space. The marking on the collar advantageously allows the substrate to be aligned with regard to the first position.

### FIELD OF THE INVENTION

The present invention relates to a substrate for use in a process with at least one micromechanical process step, a micromechanical sensor having a substrate according to the present invention, as well as a workpiece holder that is able to accommodate a substrate according to the present invention during the production of a micromechanical sensor.

### BACKGROUND INFORMATION

In the production of sensor elements, in particular high-pressure sensor elements, stainless steel substrates having diaphragms embedded into the substrate are commonly used, onto which various functional layers are applied using thin-layer technology. These functional layers include, for example, insulating layers, sensitive resistance layers, electrically conductive layers, from which conducting paths or contacts may be patterned, or even passivation layers.

In order to produce a sensor element existing as a single substrate such that it is capable of being mass-produced, it is cost-effective to process them together in groups. For this purpose, concepts have already been developed that are intended to meet the various requirements of the specific individual processes in thin-layer production. In this context, the substrate is usually accommodated on a workpiece holder that, among other things, serves to position the substrate during the individual process steps.

First of all, it is known to secure the substrate at the beginning of thin-layer production in a very massive workpiece holder and leave it in this massive workpiece holder for the entire thin-layer production. The disadvantage here is that the workpiece holder has a considerable weight and a large overall height, which complicates the individual process steps. Moreover, such a structure must be bolted in a very complex manner in order to ensure a definite position of the substrate during processing. In addition, media entrainment may occur, particularly in the case of treatment with liquid media, which makes mass production more difficult.

Secondly, it is known to use an individual workpiece holder that is adapted to the respective processing method for each individual process step of thin-layer production. Between the individual process steps, the substrates must then be received into the respective specialized workpiece holders and removed from them again at the end of the process step. The disadvantage here is a considerable assembly and handling expense. Moreover, because of the high number of possible process steps, errors may occur in the positioning of the substrate, causing a considerable amount of waste, which also complicates its ability to be mass-produced.

German Patent Application No. 199 34 114 describes a workpiece holder that is equipped with a receptacle that receives and positions the substrate. In order to prevent an axial displacement or a radial rotation of the substrate during thin-layer production, the substrate has, for example, a groove or a notch provided on the lateral wall of the substrate. Furthermore, the possibility is mentioned for the workpiece holder to have a projection that is complimentary to the groove and that engages in this groove when the substrate is placed in the workpiece holder.

### SUMMARY OF THE INVENTION

The present invention is based on a substrate having a collar, the collar having a marking.

In one embodiment of the present invention, provision is made for the substrate, in particular a thin-layer substrate, to be processed in a process with at least one micromechanical process step. Here, given at least one micromechanical process step, provision is made for the successful performance of the process step to be dependent upon the substrate being fixed in a first position. This first position is to be understood as a relative position of the substrate in space. The marking on the collar enables the substrate to be advantageously aligned with regard to the first position.

It is advantageous for the marking or feature to be provided as a recess or formation on the collar. Preferably, this marking is optically and/or mechanically detectable, for example, by an image recognition system or an electrical pushbutton switch.

In one embodiment of the present invention, the substrate is structured in such a way that the collar allows the substrate to be accommodated in a substrate carrier conceived as a workpiece holder.

In a further embodiment of the invention, the marking on the collar of the substrate is provided in such a way that the substrate may be prevented from being rotated out of the first position in the workpiece holder during processing. Moreover, such a rotation may be prevented or recognized using the marking on the collar as soon as the substrate is received into the workpiece holder.

In a preferred embodiment of the invention, various micromechanical process steps are used in the processing of the substrate. Here, provision is made, among other things, for at least one insulating, semi-conductor, metallic, or photochemical layer to be applied to the substrate, for example, by vapor deposition or sputtering. The layer thus applied may then serve as a mask for patterning the layers located below it. In general, however, patterning by photolithographic or laser patterning is provided. A further advantage of providing the collar of the substrate with the marking according to the present invention lies in the fact that two process steps, in which the position of the substrate is adjusted relative to one another in such a way that a displacement of the spatial position of the substrate would lead to imprecision in the patterning, may be performed even if the substrate leaves the first position after the first process step, for example, in order to perform another process step or to be cleaned. Because of the marking, the substrate may then be returned to the same first position. Here, it is unimportant whether the processing affects the substrate directly or a layer applied to the substrate.

A micromechanical component is advantageously produced using the substrate. In so doing, a sensor, for example, may be produced using the micromechanical processing, in particular the production of a pressure sensor being provided. In a special further embodiment of the invention, the micromechanical sensor has a diaphragm and/or a thin-layer system, the thin-layer system having at least one insulating, one semi-conductor, and/or one metallic layer.

In a particular embodiment of the invention, the marking on the collar of the substrate is structured in such a way that the marking does not cause impairment to the loading capacity, measuring sensitivity, service life, or measurement range of the micromechanical sensor.

The marking on the collar of the substrate may advantageously be used to position the micromechanical sensor, produced by the processing in specifiable and predefined alignments within the framework of installing it in the composite sensor, for example, in the welded state.

A further embodiment of the present invention relates to the workpiece holder in which the substrate according to the present invention is held during processing. At least one location that allows an optical and/or mechanical monitoring of the position of the substrate is advantageously provided on the workpiece holder. This may occur, for example, through an opening in the workpiece holder through which the position of the marking may be detected from above by an image recognition system. If it is detected that the substrate has rotated out of a predetermined position, appropriate measures may be introduced to turn the substrate back into its predetermined position, for example, the first position.

The workpiece holder may be designed in such a way that it is possible to adapt the substrate to the ambient conditions that occur during the various process steps in the processing of the substrate. Thus, for example, it is conceivable for the workpiece holder to be swiveling so as to allow the drainage of cleaning fluid.

It is advantageous that the marking is available on the collar for the entire production chain (processing and installation in the composite sensor) from the production of the substrate forward and is usable throughout. In this manner, the proneness to errors may be reduced, in contrast to concepts in which various markers are used at different points in the process.

Because the structure of the marking in the form of recesses on the collar requires the removal of only a small amount of material, it may be realized in a simple and cost-effective manner.

### BRIEF DESCRIPTION OF THE DRAWINGS

FIGS. 1a and 1b show the structure of a substrate as well as the accommodation of a substrate in a workpiece holder, as is described in German Patent Application No. 199 34 114.

FIG. 2 shows the structure of a substrate according to the present invention in a top view.

FIG. 3 shows a cross-section along the line AB in FIG. 2.

FIG. 4 shows by way of example on a workpiece holder how the workpiece holder and the structure of the substrate may be adapted to one another for the purpose of achieving a more precise positioning.

### DETAILED DESCRIPTION

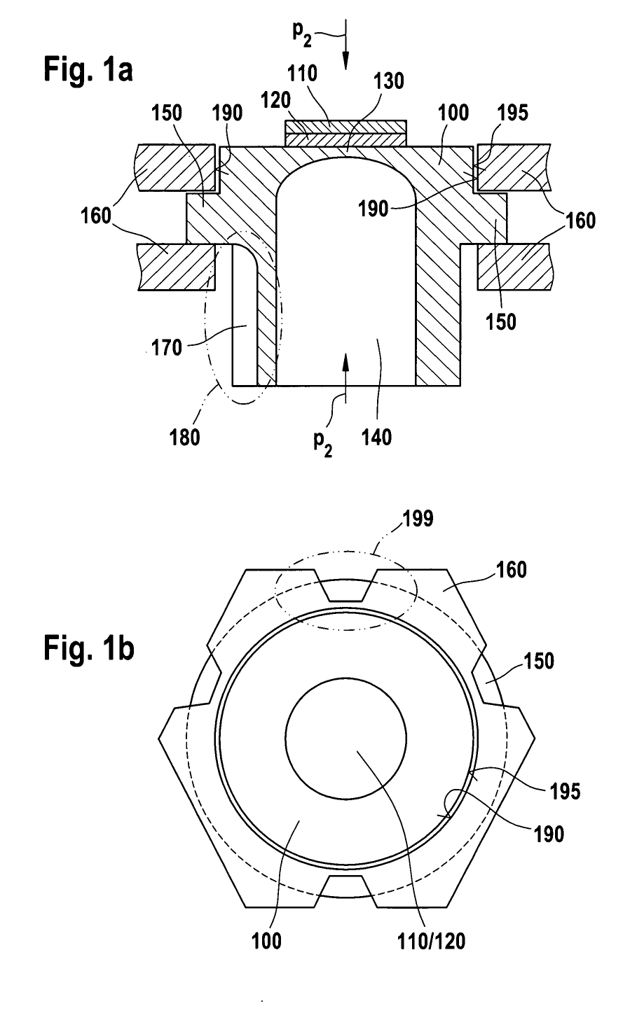

Substrate 100, which is embodied as a differential pressure sensor by way of example in FIG. 1a, has a diaphragm 130 that detects a pressure differential between pressure p₁ in a cavity 140 within the sensor and pressure p₂ outside the sensor. For this purpose, one or more layers 110 and 120, respectively, are typically applied to diaphragm 130 (which is not necessarily round) in micromechanical process steps; these layers detect deformation of diaphragm 130 and convert it into a measured quantity that may be processed further. Thus, substrate 100 and diaphragm 130 and applied layers 110 and 120 together form the sensor element of the pressure sensor. In the related art, a piezosensitive or piezoelectric resistance layer, embodied, for example, as a strain gauge in the form of a Wheatstone measuring bridge, is used to convert the deformation of the diaphragm into a measured quantity. If substrate body 100 is made of a metal, for example, steel, it is necessary to apply an insulating layer, for example, made of SiOₓ, between the substrate and the piezosensitive or piezoelectric resistance layer. In order to form the resistance layer, a material that has piezosensitive or piezoelectric characteristics is initially applied to diaphragm 130 or the insulation layer. This material may be, for example, NiCr, NiCr(Si), or doped poly-Si, to name only a few possible materials. Subsequently, the material thus applied is patterned in order to create a pattern on the diaphragm appropriate for its use as a strain gauge. For the contacting, special contact layers or a suitable layer system such as, for example, NiCr/Pd/Au or Ni is applied. Provision may also be made for only special zones on the created resistance layer to be contacted. Finally, the resistance layer is protected from environmental influences by a passivation layer, e.g., SiₓN_{y}. As a rule, however, the contacting surfaces are not passivated.

At least the piezosensitive or piezoelectric layer, the contact-layer system, and the passivation are each patterned. Processes that are typically used for this purpose are photolithographic patterning, laser patterning, and deposition using shadow masks. In general, the individual planes must be arranged very precisely relative to one another (“mask offset”). The more precisely this arrangement can be performed, the more exactly the patterns can be produced on the surface of the substrate. Among other things, this affects the precision of the sensor. Moreover, if fine and thin patterns are produced in an exact manner in the x and y directions, the possibility exists of reducing the overall size of the sensor.

The (semi-conductor-like) thin-layer process for the representation of the thin-layer system, as it was described above, mostly represents a processing of the individual sensor elements in a larger composite, which allows a considerable reduction of the process costs. Such a composite is realized with the aid of a workpiece-holder system into which the individual (steel) substrates to be coated are inserted.

Besides clamping the substrates in a rigid workpiece holder in which the substrates will remain for the entire thin-layer process, there are workpiece-holder systems that allow adaptation to each of the individual processes using various components. As a rule, the option of adaptation to the demands of the individual processes leads to considerably larger yields. For mass production, it is favorable for the substrates to remain in one base plate throughout the entire thin-layer process, upon which process-specific cover plates are then placed.

As a rule, individual substrates 100 are positioned in a workpiece holder 160 using a “mechanical guidance” of the substrates by way of their outer contour, as is shown by way of example in FIGS. 1a and 1b and described in German Patent Application No. 199 34 114, which is described above. Thus, outer surface 195 of substrate 100 is “guided” into a predefined position by outer surface 190 of workpiece holder 160. A simple examination of the extent to which the predefined position is achieved may be conducted, for example, in region 199.

The requirement for a precise positioning of the individual elements in the plane of the workpiece holder (x and y directions) leads to high tolerance demands on individual measurements of the outer contour of the substrates and on the corresponding measurements of the components of the workpiece holder. Besides positioning in the x and y direction, a rotating of the sensor elements in the workpiece holder between the processing of the individual mask levels must be prevented.

As a rule, the anti-rotation protection leads to special demands on the outer contour of the sensor elements (e.g., a groove) and thus makes it more difficult to miniaturize the overall size and/or to increase the packing density. In the case of substrates 100 described in German Patent Application No. 199 34 114, for anti-rotation protection, a groove 170 is provided as a recess in the lateral wall of substrate 100 below collar 150. This allows the anti-rotation protection to be realized, but represents at the same time a weakening of the lateral wall, as may be seen in region 180, under hydraulic load, which quickly becomes a limiting factor when the component is miniaturized. Moreover, it is not possible to monitor the rotating of the substrate in the workpiece holder using a simple visual check in region 199.

However, with the present invention, it is possible to perform a definite alignment of the substrate using an optically recognizable feature and/or marking on substrate 100, both during processing of the thin-layer process and during the subsequent installation of the sensor element in the composite sensor. Here, the feature is placed on collar 150 of substrate 100 in such a way that a weakening of the lateral wall of the substrate is prevented.

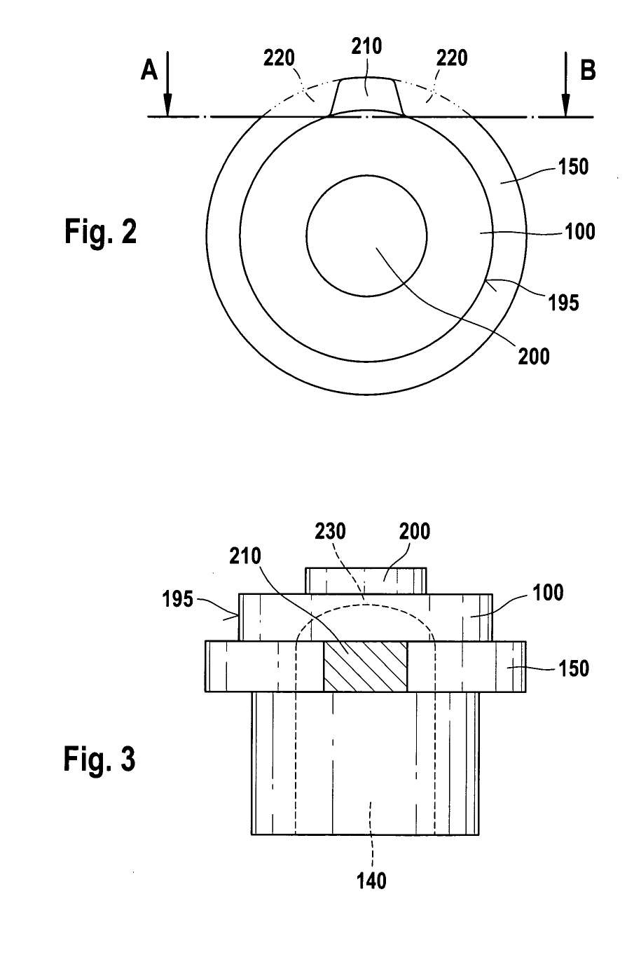

FIG. 2 shows a possible embodiment of collar 150 according to the present invention. Here, material is removed from collar 150 at certain points 220 until a “nose” 210 remains from original collar 150. In a cross-section along line AB, FIG. 3 shows substrate 100 according to the exemplary embodiment introduced according to FIG. 2. As may be seen from FIGS. 2 and 3 as compared to FIG. 1a (which shows related art), due to the production of feature 210, the substrate lateral wall, which separates internal pressure p₁ in cavity 140 from external pressure p₂, is not weakened, thus allowing a further miniaturization of the sensor element. Moreover, neither diaphragm 230 nor applied layers 200 (and thus the function of the sensor) are impaired by the structure of collar 150 having feature 210. Because substrate 100 continues to be held in workpiece holder 300 (corresponds to workpiece holder 160) by the part of collar 150 that were not removed, there should be no loss of stability.

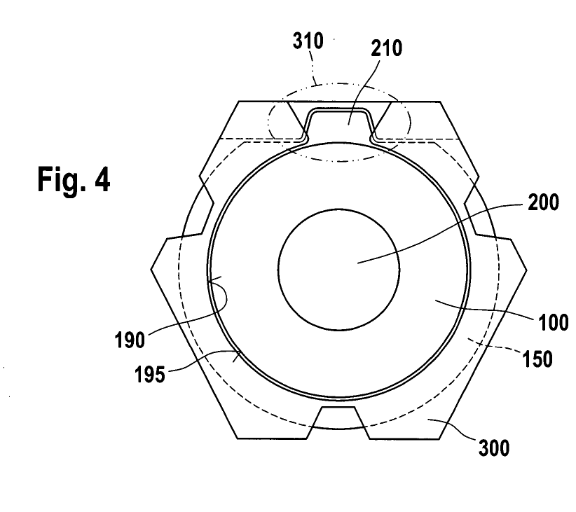

FIG. 4 shows a top view of an embodiment of workpiece holder 300. Here, a special region 310 is structured in such a way that marking 210 may be recognized from above in order to determine the alignment. In a further exemplary embodiment, workpiece holder 300 may also be structured at the level of marking 210 in such a way that it is provided for receiving formation 210. Thus in practice, snapping substrate 100 into workpiece holder 300 allows a predefined alignment and fixation of the substrate with respect to the process steps to be performed.

1. A substrate comprising:
a collar having a marking.

2. The substrate according to claim 1, wherein the substrate is a thin-layer substrate, and wherein the substrate is provided in a process having at least one micromechanical process step, in which:
(a) in order to perform at least one micromechanical process step, the substrate is aligned in a first position, the first position representing a fixation of a relative spatial position of the substrate, and
(b) the marking allows the substrate to be aligned with respect to the first position.

3. The substrate according to claim 1, wherein the collar has one of a recess and a formation as a marking, the marking being detectable at least one of optically and mechanically.

4. The substrate according to claim 1, wherein the collar is accommodated in a substrate carrier embodied as a workpiece holder.

5. The substrate according to claim 4, wherein the marking on the collar prevents an accidental rotation of the substrate when accommodated in the workpiece holder.

6. The substrate according to claim 1, wherein the substrate is processed using various micromechanical process steps, the micromechanical process steps including that:
(a) at least one layer is applied to the substrate, the at least one layer being at least one of insulating, a semi-conductor, metallic, and photochemical,
(b) a patterning of the layer is provided, the patterning being one of a photolithographic patterning and a laser patterning, and
(c) at least two process steps for processing at least one of the substrate and the applied layer are performed in coordination with one another, the processing in the at least two process steps being sensitive with respect to a preferred alignment of the substrate relative to one another.

7. The substrate according to claim 1, wherein the substrate is provided for producing a micromechanical component, at least one of:
(a) the micromechanical component representing a sensor,
(b) the substrate being at least partially made of steel, and
(c) the micromechanical component having at least one layer, the at least one layer being at least one of a diaphragm, a thin-layer system, a semi-conductor, and metallic.

8. The substrate according to claim 7, wherein the marking on the collar of the substrate is specifiable independently of:
(a) a load capacity,
(b) a measuring sensitivity,
(c) a service life, and
a measurement range of the sensor.

9. A micromechanical sensor comprising:
a substrate including a collar, the collar having a marking, the marking allowing a predefined alignment of the sensor in a housing.

10. A workpiece holder for receiving a substrate including a collar, the collar having a marking, the workpiece holder comprising:
at least one point on the workpiece holder for allowing a position of the substrate to be monitored in at least one of an optical and a mechanical manner.

11. The workpiece holder according to claim 10, wherein various process steps are provided for a processing of the substrate, a structure of the workpiece holder allowing the substrate to be adapted to ambient conditions necessary during the various process steps.
